(19) United States
(12) Patent Application Publication
(10) Pub. No.: US 2006/0167753 A1
(43) Pub. Date: Jul. 27, 2006

(54) Information and promotional offer management and distribution systems and methods

(76) Inventors: Brian Teague, Dallas, TX (US); Daniel Wagstaff, Dallas, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/339,893

(22) Filed: Jan. 26, 2006

Related U.S. Application Data
(60) Provisional application No. 60/647,284, filed on Jan. 27, 2005.

(51) Int. Cl. G06Q 30/00

(52) U.S. Cl. 705/14

(57) ABSTRACT

A method for information and promotional offer generation and distribution comprises creating a user profile. A merchant profile is created and an offer profile is created. A request is received from a user for a promotional offer. A promotional offer coupon is created with a unique tracking code based on the received request from the user, the user profile, and the offer profile. The promotional offer coupon is sent to the user based on the user profile. The offer profile is updated to reflect the sent promotional offer coupon.

This application claims priority and the benefit under 35 U.S.C. § 119(e) from U.S. provisional patent application 60/647,284 for “System and Method for the Request (opt-in) and Subsequent Distribution of Offers Via Email and SMS-Text Messaging” filed Jan. 27, 2005, which is hereby incorporated by reference.

### BACKGROUND

1. Field of the Invention

The present invention relates generally to information distribution and in particular to information and promotional offer management and distribution systems and methods.

2. Description of Related Art

Modern mass marketing and information delivery systems typically provide information and advertising that encourages the recipient to purchase the advertised products and/or services. In one sense, every advertisement or “ad” is a contractual offer to the consumer. Generally, “pure” ads offer the promise of good times or good feelings if the consumer purchases the product/service. However, many ads are more expressly offers, promising a discounted price or free goods and/or services if the consumer purchases the underlying product/service. A print flyer with an attached coupon is a simple example of offer-type advertisements. Consumers using coupons are promised a price discount in exchange for purchasing the advertised product.

Advertising offers are typically distributed in a variety of ways. Radio and television ads, for example, are massively distributed. Because there is no print capability in radio or television, these advertisements are typically closer to pure ads. Additionally, broadcast ads cannot be restricted to subsets within the viewing/listening audience—everyone in the audience sees and/or hears the ads. Broadcast media is also very expensive.

Print media also typically include advertisements and more often also include printed offers with detachable coupons that are slightly more narrowly targeted to those consumers who ordinarily read the medium (for example, fashion magazine subscribers or automobile enthusiasts). But typical print media cannot be easily restricted to a subset of the subscribers/readers. As with broadcast media, the advertisements are shown to anyone who picks up the magazine or newspaper. Print advertising/offer distribution is also very expensive. Further, consumers typically must remove the coupon and physically present it to a merchant for redemption. This restricts the number of coupons available in a single copy of a print medium. Moreover, consumers must remember to keep track of the coupon

Recently, the advent of the Internet has introduced more narrowly focused targeted advertising—for example, tracking cookies and purchase/browsing histories attempt to determine what ads a consumer might be less uninterested in seeing. Further technological advances including email and cell phones have brought new avenues for advertisement and communication with customers. These avenues remain substantially under-utilized. Furthermore, unscrupulous and sharp business practitioners have been massively abusing the more recent technological advancements in communications.

In particular, the prevalence of electronic mail users resulted in the development of a number of operations that send massively distributed, wholly untargeted and unsolicited commercial email, often over the express and repeated objections of the recipients. This phenomenon of unsolicited commercial email (UCE) or “spam” has spilled over into fixed-site text messaging and mobile telephony. Worse, almost all of this spam is fraudulent, wholly unsuitable for the recipient, proposes illegal activity bothersome, voluminous, obnoxious, and/or otherwise provides a negative incentive to the recipient to purchase the advertised product or take advantage of the offer. Further, spam is not typically targeted to primarily those consumers that might be interested in the product, and is instead sent to every known consumer in the database. Besides providing a drain on resources and causing waste of countless millions of dollars annually in virus propagation and spam prevention, spam provides a very low advertisement-to-sale ratio and is very inefficient.

Efforts to regulate spam through government intervention have met with mixed results. One framework to handle the increasing cost of spam is the distinction between “opt-in” and “opt-out” marketing databases. Generally, “opt-in” requires consumers to affirmatively request to be put on an ad distribution list, while “opt-out” allows marketers to send unsolicited advertisements until the consumer opts out of the list. Both methods are subject to abuse. The worst spam offenders follow neither system and do not care whether the consumer opts-in or out. More modern tyrants of spam, however, propose an opt-out method where consumers are subjected to a barrage of spam until they can expressly request not to be so assaulted.

Opt-in systems were therefore designed to require express permission to send advertisements to the consumer. Rarely do consumers actually opt-in to receive advertisements alone. Typically, consumers only opt-in when they desire programming and/or content that is also accompanied by ads, not the ads themselves. Some consumers are willing to tolerate the ads if only to access the desired content.

However, even with opt-in advertising, consumers have unmet demands, or demands of which they are unaware until presented with options. Moreover, consumers have privacy concerns—they do not want casual observers to be aware of their desires or the types of information, good, and/or services they seek. Similarly, consumers also have security concerns—they do not want their private information to be accessible to anyone without their express permission.

Further, consumers very much do not want to be bothered by unwanted ads in undesirable formats. Typical systems for opt-in advertising do not provide a mechanism whereby a user can specify whether they would prefer to receive offers via text message, email, voicemail, etc. As a majority of consumers have cell phones and other mobile devices, the ability to provide desired offers and promotional information though these mobile devices remains largely untapped. Thus, advertisers have a need for the ability to efficiently, effectively, and discreetly communicate not only the terms of an offer but the instructions within an offer via email or text messaging to a user's mobile device.

A need exists, therefore, for information and promotional offer management and distribution systems and methods that overcome problems and disadvantages associated with prior systems and methods.

All references cited herein are incorporated by reference to the maximum extent allowable by law. To the extent a reference may not be fully incorporated herein, it is incorporated by reference for background purposes and indicative of the knowledge of one of ordinary skill in the art.

### SUMMARY

The problems presented in previous systems and methods are solved by the systems and methods of the present invention. In accordance with one embodiment of the present invention, information and promotional offer management and distribution systems and methods are provided.

In particular, in one embodiment, a method for information and promotional offer generation and distribution comprises creating a user profile. A merchant profile is created and an offer profile is created. A request is received from a user for a promotional offer. A promotional offer coupon is created with a unique tracking code based on the received request from the user, the user profile, and the offer profile. The promotional offer coupon is sent to the user based on the user profile. The offer profile is updated to reflect the sent promotional offer coupon.

One advantage of the present invention is the ability to efficiently, effectively, and discreetly communicate not only the terms of an offer but the instructions within an offer to a user's mobile device. Another advantage is the ability for a user to not only request an offer but to have the offer sent to them via email, SMS-text message, and/or other desired delivery methods. Another advantage is to provide the user with a quick and easy 1-step or 2-step process to receive a requested offer.

Yet another advantage of the present invention is that the use of text messaging and other electronic delivery mechanisms is a quick, easy, and paperless way to distribute a requested offer to a user. Another advantage is that by creating a member profile the user can to opt-in to receive special offers, promotions, and discounts. The user then has the ability to determine when and how they receive those offers. Still another advantage is to provide a system and method for users to request an offer on a website or through an interactive voice response (IVR) system.

Still another advantage is to provide a system and method whereby a user requests an offer and is given a choice as to how they want to receive it. Yet another advantage is to provide a system and method whereby a user clicks on an offer on a website and then chooses whether the offer is emailed to them or sent to their mobile phone via SMS-text message or other mobile messaging mechanism. Another advantage is to provide a method and process whereby a user is presented with an offer within an IVR system and if the consumer so chooses, the offer is sent to their mobile phone via SMS-text message or other mobile messaging mechanism.

Yet another advantage is to provide a method wherein an offer and its terms are embedded in an email and/or SMS-text message or other mobile messaging mechanism. Another advantage is to provide a system and method whereby a user creates a member profile on a website and based upon pre-selected criteria stored in a database, the user can have an offer sent to either their email address or their mobile phone via SMS-text message or other mobile messaging mechanism in a one-step process. Another advantage is to provide a method and process whereby a user can click on an offer on a website and, in a two-step process, provide an email address or mobile phone number to receive the offer.

Still another advantage is to provide a system and method whereby a text message stored on a mobile phone comprises a coupon or offer. Another advantage is to provide the ability to receive an offer via SMS-text message to a user's mobile phone through an IVR system, including the ability for the IVR system to capture and record a user's mobile phone number to send an SMS-text message to a user's mobile phone based on selection of an offer.

Other objects, features, and advantages of the present invention will become apparent with reference to the drawings and detailed description that follow.

### BRIEF DESCRIPTION OF THE DRAWINGS

FIG. 1 is a block diagram illustrating an information and promotional offer management and distribution system in accordance with one embodiment of the present invention.

FIG. 2 is a block diagram illustrating an information distribution system in accordance with one embodiment of the present invention.

FIG. 3 is a block diagram illustrating a content management system in accordance with one embodiment of the present invention.

FIG. 4 is a block diagram illustrating an example interactive voice system configuration in accordance with one embodiment of the present invention.

FIG. 5 is a block diagram illustrating an example electronic promotional offer coupon in accordance with one embodiment of the present invention.

FIG. 6 is flow diagram illustrating an information and promotional offer management and distribution method in accordance with one embodiment of the present invention.

FIG. 7 is a flow diagram illustrating an electronic promotional offer coupon redemption method in accordance with one embodiment of the present invention.

FIG. 8 is a flow diagram illustrating an electronic promotional offer tracking and management method in accordance with one embodiment of the present invention.

### DETAILED DESCRIPTION

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical mechanical and electrical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

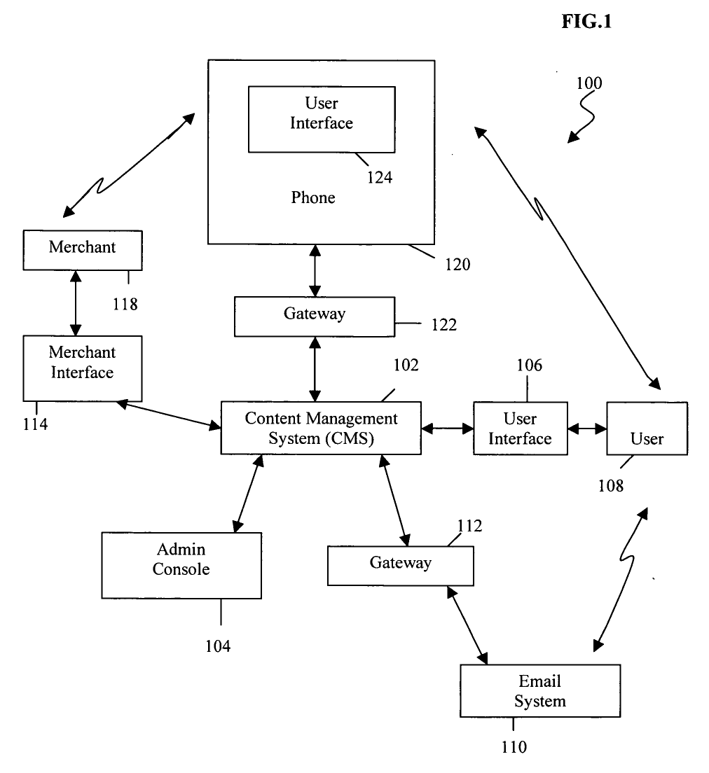

Referring now to FIG. 1, the reference numeral 100 generally designates an information and promotional offer management and distribution system in accordance with one embodiment of the present invention. System 100 includes content management system (CMS) 102, described in additional detail below. Generally, CMS 102 is a hardware or software system, such as, for example, a server, that includes various modules that store data, process data, and distribute information and promotional offers, among other things.

CMS 102 couples to an administrative console 104. Administrative console 104 is configured to allow a user to access and manipulate the data stored in CMS 102 and to perform other tasks. Administrative console 104 can be, for example, a stand-alone workstation, a graphical user interface (GUI) embedded in a desktop computer, or other suitable interface.

System 100 also includes a user interface 106. User interface 106 couples to CMS 102 and in one embodiment is a GUI coupled to CMS 102 through the Internet. Generally, user interface 106 is configured to allow a user 108 to interact with one or more modules of CMS 102. In a particular embodiment, user interface 106 is configured to receive user information from user 108 and to transmit received user information to CMS 102. As described in more detail below, the user information can be collected by CMS 102 and stored in a database. Moreover, the collected user information can be organized into a user profile and can contain, for example, user contact information, user promotional offer type preference information, user promotional offer delivery preference information, and other suitable information.

In the illustrated embodiment, user 108 also has access to an email system 110. Email system 110 is an otherwise conventional electronic mail delivery system and can include an email display/creation GUI or “client,” an email distribution hub or server. CMS 102 is configured to access email system 110 through a gateway 112. Gateway 112 is an otherwise conventional electronic mail gateway.

System 100 also includes a merchant interface 114. Merchant interface 114 couples to CMS 102 and in one embodiment is a GUI coupled to CMS 102 through the Internet. Generally, merchant interface 114 is configured to allow a merchant 118 to interact with one or more modules of CMS 102. In a particular embodiment, merchant interface 114 is configured to receive merchant information from merchant 118 and to transmit received merchant information to CMS 102. As described in more detail below, the merchant information can be collected by CMS 102 and stored in a database. Moreover, the collected merchant information can be organized into a merchant profile and/or an offer profile and can contain, for example, merchant contact information, directions to the merchant's place of business, the type of business, merchant promotional offer type preference information, merchant promotional offer delivery preference information, merchant referral codes, the terms of one or more promotional offers sponsored by the merchant, and other suitable information.

In the illustrated embodiment, user 108 also has access to a mobile device 120 and is configured to send information to and receive information from CMS 102 through gateway 122. Gateway 112 is an otherwise conventional mobile device gateway. In the illustrated embodiment, and for ease of explanation, mobile device 120 is depicted as a mobile or “cellular” telephone. One skilled in the art will understand that mobile device 120 can also be a wireless personal data assistant (PDA), a wireless email device, or other suitable mobile device. Generally, mobile device 120 is an otherwise conventional mobile device, described in further detail below.

Mobile device 120 includes a user interface 124. Generally user interface 124 is an otherwise conventional mobile device user interface and is configured to allow user 108 to access various features in operation of mobile device 120. In the illustrated embodiment, user interface 124 can include a GUI configured for Internet applications, and can be configured to run applications coded in, for example, extended markup language (XML), hyper-text markup language (HTML), Java, Flash, or other suitable Internet-based programming languages. Moreover, mobile device 120 is also configured to interact with an interactive voice recognition (IVR) system of CMS 102.

Generally, in operation, in one embodiment system 100 operates as follows. User 108 creates a user profile on CMS 102 through user interface 106, containing contact and other identifying information and the user's preferences for offer content and delivery. The user can subsequently modify any of the information in the user profile, except information added by the CMS 102 itself, such as tracking information, as described in more detail below. Specifically, the user profile also includes tracking and statistical information relating to, for example, the number of offers the user has requested, the number of offers the user has redeemed, the time of day or day of the week when the user requests/redeems offers, the type of offer, and/or other suitable information.

A merchant 118 creates a merchant profile on CMS 102 as well as an offer profile through merchant interface 114. As described in additional detail below, the merchant profile contains similar information as the user profile. The offer profile contains details specific to a particular offer sponsored by the merchant, including, for example, the terms of the offer, expiration settings, tracking information, and other suitable information.

Subsequent to establishing a user profile on CMS 102, user 108 initiates a mobile telephone call to CMS 102 through mobile device 120 though gateway 122. In one embodiment, user 108 is connected to an IVS of CMS 102. In response to received user information, CMS 102 generates and transmits offers to the user. In one embodiment, CMS 102 searches an offer database for offers that meet either pre-defined user criteria (from the user's profile), or newly input criteria generated in response to questions presented to the user while interacting with the system. When a matching offer is found, CMS 102 generates a tracking code, embeds the tracking code in a message to the user, and sends the message to the user's desired destination device, such as, for example, the user's cell phone/SMS receiver and/or the user's email address.

The received message with the embedded tracking code serves as the coupon and is displayed as an image in a GUI within user interface 124. In a preferred embodiment, user 108 selects a destination from a list of options, such as, for example, a restaurant, and CMS 102 presents user 108 with one or more offers corresponding to that restaurant. In one embodiment the embedded tracking code is an alphanumeric code. In an alternate embodiment, the embedded tracking code is a bar code. In one embodiment, the embedded tracking code contains information uniquely identifying the merchant associated with the promotional offer. In an alternate embodiment, the embedded tracking code includes referral information. In an alternate embodiment, CMS 102 generates and embeds a separate referral tracking code, which includes referral information. One skilled in the art will understand that other configurations can also be employed.

Subsequently, user 108 presents the received coupon to merchant 118. Merchant 118 verifies the tracking code through merchant interface 114 and, upon a determination that the coupon is still valid, honors the coupon. CMS 102 updates the offer status and tracks the transaction. Subsequently, merchant 118, through CMS 102, reconciles the coupons allowed with the coupons issued and redeemed. Further reconciliation includes referral transactions and merchant payment to the system operator.

Generally, in an alternate embodiment, in operation, system 100 operates as follows. User 108 dials a predetermined telephone number and connects to an IVR system of CMS 102. The IVR system presents one or more offers to user 108. Once an offer is heard that appeals to user 108, user 108 can select the offer through user interface 124, and can elect to receive the offer via SMS-text message to phone 120 or via email through email system 110. As above, user 108 presents phone 120 to the merchant 118 that initiated the offer and in turn, receives the terms of the offer embedded in the SMS-text message. Alternately, user 108 connects to CMS 102 through user interface 106 through a website on the Internet. User 108 clicks on an offer through a GUI and is given the option of receiving the offer via email through email system 110 or SMS-text message to phone 120. If the offer is sent via email, user 108 prints the offer and presents the offer to merchant 118. If the offer is sent via SMS-text message, user 108 presents phone 120 (specifically user interface 124) to merchant 118 and in turn, receives the terms of the offer embedded in the SMS-text message.

Additionally, in one embodiment system 100 is configured to deliver to user 108 requested non-offer information, such as, for example, directions to a place of business for merchant 118, notices of special events, and other suitable information. In an alternate embodiment, system 100 is configured to forward reservation information and/or to initiate a live chat session between user 108 and merchant 118 through mobile device 120.

While the above embodiment has been described primarily with respect to SMS-text messaging, one skilled in the art will understand that the present invention is not restricted to SMS-text messaging. Further, any suitable information delivery mechanism can also be employed, including, but not limited to, MMS, and/or other next generation mobile messaging system.

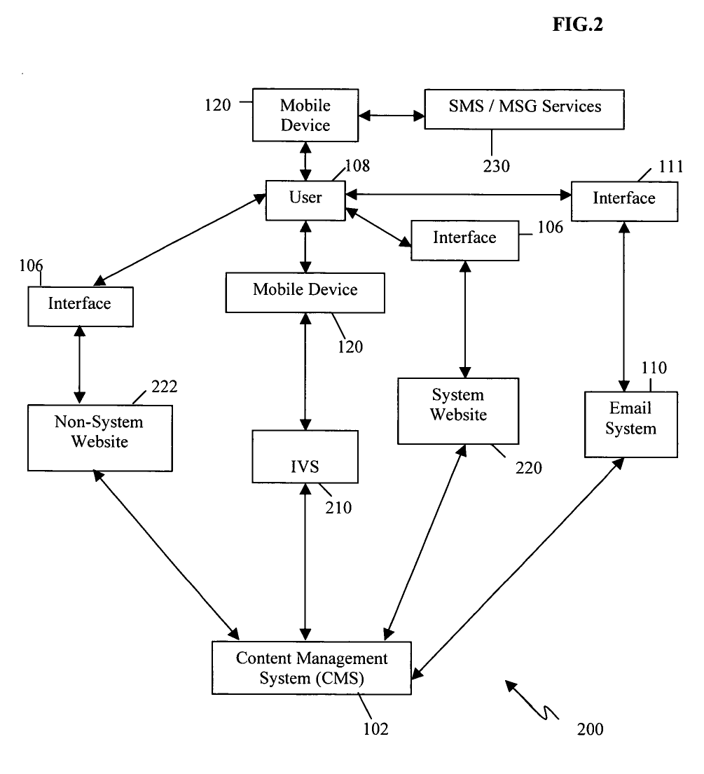

Referring now to FIG. 2, the reference numeral 200 generally designates an information distribution system in accordance with one embodiment of the present invention. Generally, system 200 illustrates a variety of mechanisms through which user 108 can interact with CMS 102. As described above, user 108 can interact with CMS 102 through mobile device 120 coupled to an IVS 210.

Additionally, user 108 can interact with CMS 102 through a system website 220 through a user interface 106. As used herein, a system website is a website hosted on CMS 102 and configured to provide user 108 with a variety of information input and output mechanisms, especially for user 108 to provide user information and preferences.

User 108 can also interact indirectly with CMS 102 through a non-system website 222 through user interface 106. Generally, as used herein, a non-system website is a website hosting a banner ad or other clickable presentation or offer that is coupled to CMS 102. User 108 can click on the offer and the non-system interacts with CMS 102 to identify the terms of the offer and the user's preferred delivery method, including any referral information.

User 108 can also interact with CMS 102 to receive requested offers or other information through email system 110 through an email interface 111, as described above. Further, user 108 can interact with CMS 102 through received SMS-text messages through messaging services 230 and mobile device 120. As described above, messaging services 230 can include MMS services, mobile email delivery, next generation messaging services and/or other suitable services.

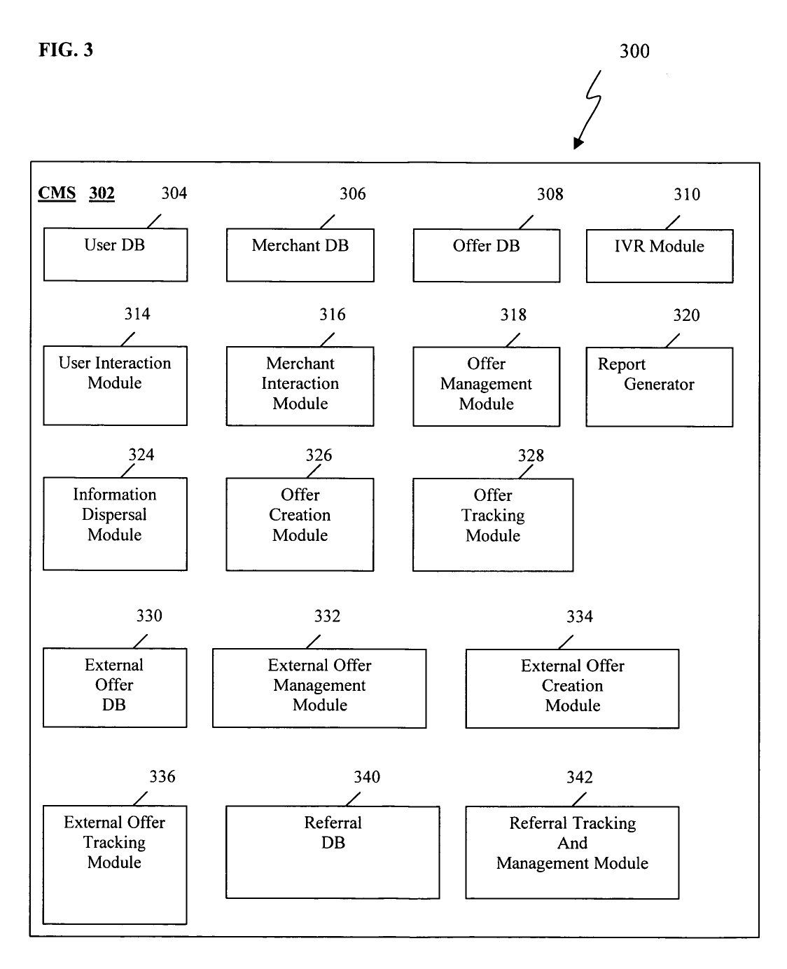

Referring now to FIG. 3, the reference numeral 300 generally designates a content management system in accordance with one embodiment of the present invention. System 300 includes CMS 302. In one embodiment, CMS 302 is configured as CMS 102 of FIG. 1, above. In the illustrated embodiment, CMS 302 includes a variety of modules. In particular, CMS 302 includes user database 304, merchant database 306, and offer database 308.

Generally, user database 308 is configured to receive and store user information. Similarly, merchant database 306 is configured to receive and store merchant information and offer database 308 is configured to receive and store promotional offer information. In one embodiment, to address privacy concerns, merchants cannot access user database 304. Instead, offer creation module 326 automatically assesses which users get which offers, and the users remain anonymous to the merchants. Similarly, some merchants do not want every user to know what and how they are advertising. Accordingly, users cannot access merchant database 306. Instead, the users only see those offers for which they have been selected (either through their criteria, or the merchant's criteria).

CMS 302 also includes an IVR module 310 configured to support an IVR system to interact with a user and to retrieve user information and user communications for forwarding on to other modules, as described in more detail below.

CMS 302 also includes user interaction module 314 and merchant interaction module 316. Generally, user interaction module 314 is configured to interact with a user to receive user information for forwarding to user database 304. Similarly, merchant interaction module 316 is configured to interact with a merchant to receive merchant information for forwarding to merchant database 306. CMS 302 also includes offer management module 318. Generally, offer management module 318 is configured to receive offer information from a merchant and to manage offer information through interaction with offer database 308.

CMS 302 also includes information dispersal module 324. Generally, information dispersal module 324 is configured to receive requests for information from a user through user interaction module 314, to collect requested information from merchant database 306, and to forward requested information to the user. As described above, only certain merchant information is available to users, such as, for example, merchant contact information, directions to the merchant's place of business, and other suitable information.

CMS 302 also includes offer creation module 326 and offer tracking module 328. Generally, offer creation module 326 is configured to retrieve requested offer information from offer database 308, to retrieve an offer tracking code from offer tracking module 328, to embed a retrieved offer tracking code into an offer coupon, and to transmit the offer coupon to the user. In an alternate embodiment, offer creation module 326 is further configured to retrieve a referral code from referral tracking and management module 342 and to embed a retrieved referral code into the offer coupon.

Generally, offer tracking module 328 is configured to generate a unique tracking code for each offer and each coupon associated with an offer and to forward the unique tracking code to offer creation module 326. In an alternate embodiment, offer tracking module 328 is further configured to retrieve a referral code from referral tracking and management module 342 and to incorporate the referral code into the tracking code. In an alternate embodiment, offer tracking module 328 is configured to generate a bar code embodying the tracking code.

CMS 302 also includes a report generator 320. Generally report generator 320 is configured to retrieve information from one or more modules of CMS 302 and to generate reports based on retrieved information.

CMS 302 also includes external offer database 330, external offer management module 332, external offer creation module 334, and external offer tracking module 336. Generally, external offers are offers generated through non-system websites. Generally, external offer database 330 is configured to receive and store external offer information. Generally, together, external offer database 330, external offer management module 332, external offer creation module 334, and external offer tracking module 336 perform similar tasks as their offer counterparts. For example, external offer management module 332 performs similar tasks as offer management module 318, and so forth.

CMS 302 also includes referral database 340 and referral tracking and management module 342. Generally, referral database 340 and referral tracking and management module 342 perform similar tasks as their offer counterparts, with respect to referral information. For example, in one embodiment, referral tracking and management module 342 is configured to generate a unique referral code based on referral information from referral database 340 and to track referral codes used in redeemed coupons.

Thus, generally, the above systems operate as follows in an example, non-limiting embodiment. There is an interface that can be used by any web application to query for available coupons, reserve them, send them via text message, or un-reserve them to be made available again. The interface controls access to the SMS gateway.

The interface is responsible for taking the establishment code requested (a unique merchant identification code) and pulling the following information from the databases in order to generate message text to be displayed by the requesting application to the user, or to be included in a outgoing text message. The text coupon can include, for example, a) The coupon identifier/tracking code; b) the Establishment name; c) the item(s) being discounted; d) the promotional offer expiration date; and/or e) any conditions that must be met in order to redeem the promotional offer coupon.

In addition to tracking that information for each coupon, the CMS also tracks the promotion start date, the date the coupon was reserved, and the date the coupon was sent through the SMS gateway. The promotion start date is used in conjunction with the reservation date to determine if the coupon is available. If the request date is greater than the start date and the coupon has never been previously reserved, then the coupon is available.

The interface will mark the coupon as reserved after it has been requested. A separate request for the web application initiates the actual SMS text message. That request specifies the cell phone number, the coupon code, and the text message to send. In an alternate embodiment, the interface does not require an application to provide the text message to send. Once the coupon has been sent as a text message, the interface marks the SMS sent date in the offer database.

Further, in an alternate embodiment, the various system components include a promotional offer coupon management subsystem. A front end GUI allows (merchant or administrative) users to load coupons into the system. This GUI allows users to define promotion types (what items are being promoted), restriction types (conditions to meet in order to redeem), promotion start dates, expiration dates, coupon identifiers and other suitable information. A coupon number generator creates the tracking code, which can include a referral code, and allows users to choose from drop-down GUI menus what the discount will be for and what restrictions will be in place. A reporting module and/or GUI tracks coupons by one of many variables, including establishment date, redemption information and other suitable variables.

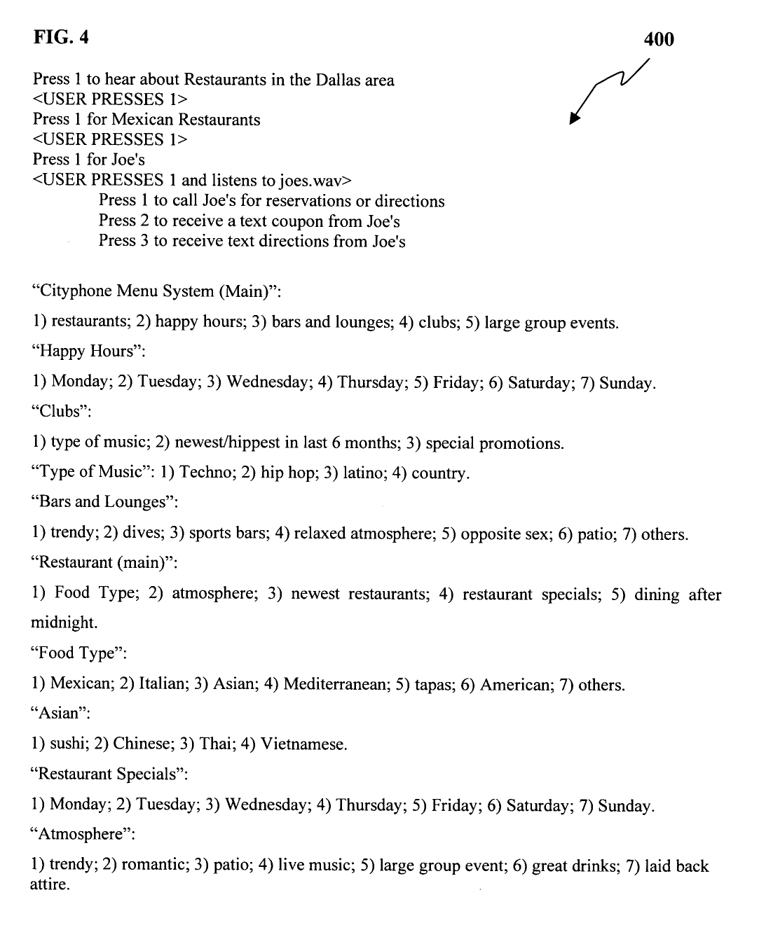

Referring now to FIG. 4, the reference numeral 400 generally designates an interactive voice recognition system configuration in accordance with one embodiment of the present invention. IVR system configuration 400 includes a number of exemplary menu options. For example in one embodiment, an exemplary interaction could be as follows:

Press 1 to hear about Restaurants in the Dallas area

<USER PRESSES 1>

Press 1 for Mexican Restaurants

<USER PRESSES 1>

Press 1 for Joe's

<USER PRESSES 1 and listens to joes.wav>

Press 1 to call Joe's for reservations or directions

Press 2 to receive a text coupon from Joe's

Press 3 to receive text directions from Joe's

In an alternate embodiment, the user can press 2 to receive a a text coupon upon hearing a good restaurant choice. In an alternate embodiment, the user can press 3 for text directions. Thus, generally, the interactive system is configured to deliver promotional offer coupons and requested information to a user.

In an alternate menu tree, as depicted in FIG. 4, users are presented with a variety of menu options, and can select sub-menus from within those options. For example, as illustrated, the “Cityphone Menu System (Main)” includes options for 1) restaurants; 2) happy hours; 3) bars and lounges; 4) clubs; and 5) large group events. The “Happy Hours” menu includes options for 1) Monday; 2) Tuesday; 3) Wednesday; 4) Thursday; 5) Friday; 6) Saturday; and 7) Sunday. The “Clubs” menu includes options for 1) type of music; 2) newest/hippest in last 6 months; and 3) special promotions. The “Type of Music” menu includes options for 1) Techno; 2) hip hop; 3) latino; 4) country. The “Bars and Lounges” menu includes options for 1) trendy; 2) dives; 3) sports bars; 4) relaxed atmosphere; 5) opposite sex; 6) patio; and 7) others.

Similarly the “Restaurant (main)” menu includes options for 1) Food Type; 2) atmosphere; 3) newest restaurants; 4) restaurant specials; and 5) dining after midnight. The “Food Type” menu includes options for 1) Mexican; 2) Italian; 3) Asian; 4) Mediterranean; 5) tapas; 6) American; and 7) others. The “Asian” menu includes options for 1) sushi; 2) Chinese; 3) Thai; and 4) Vietnamese. The “Restaurant Specials” menu includes options for 1) Monday; 2) Tuesday; 3) Wednesday; 4) Thursday; 5) Friday; 6) Saturday; and 7) Sunday. The “Atmosphere” menu includes options for 1) trendy; 2) romantic; 3) patio; 4) live music; 5) large group event; 6) great drinks; and 7) laid back attire.

Thus, the user is presented with a variety of options. In one embodiment, the user can press “2” at any time to receive a promotional offer coupon, if any are available, for whatever appropriate sub-menu or establishment is currently the selected menu choice. Thus, the user is presented with affirmatively opt-in offers that are highly targeted to the user's desires at that precise moment.

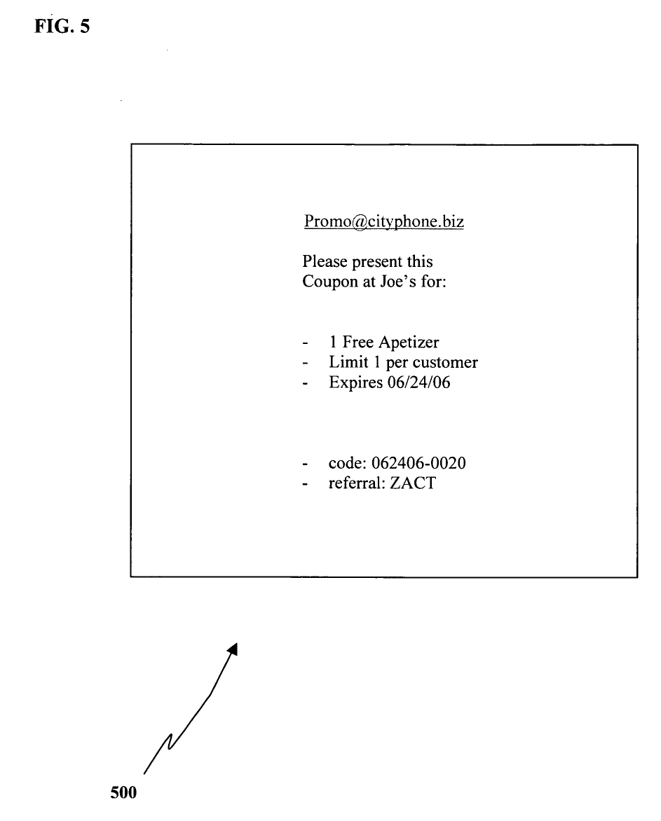

Referring now to FIG. 5, the reference numeral 500 generally designates an electronic promotional offer coupon in accordance with one embodiment of the present invention.

Generally, the details of the electronic promotional offer coupon can be described with respect to various points of a method to generate, distribute, and redeem the coupons in accordance with one embodiment of the present invention. An administrative user accesses the CMS to create establishments. An admin uses the coupon management system to create the coupons and associates them with the establishments, just as a performance review can be created for an establishment.

A user accesses the system and browses for an establishment. Upon finding an establishment, the user is presented with a link to a coupon for that establishment, if one is available. If the user clicks on the coupon link, the user is prompted with the description of the coupon and an option to receive the coupon. In one embodiment, this step is omitted, and the promotional offer coupon is sent upon the user clicking the link.

If the user was not previously logged onto the system, the system prompts for a mobile number to send the coupon to (and a message notifying the user that registration with the system allows the user to bypass the number insertion step. The user selects to receive the coupon and is returned to the screen of the establishment they were looking at, while the coupon is sent to their mobile number and/or to an email address.

Thus, the specifics of coupon 500 include a return address, “promo@cityphone.biz,” term instructions, a coupon code, and a referral code. In the illustrated embodiment, coupon 500 is an SMS-text message. As described above, coupon 500 can comprise an email message, an MMS message, a next generation messaging communication, or other suitable electronic message.

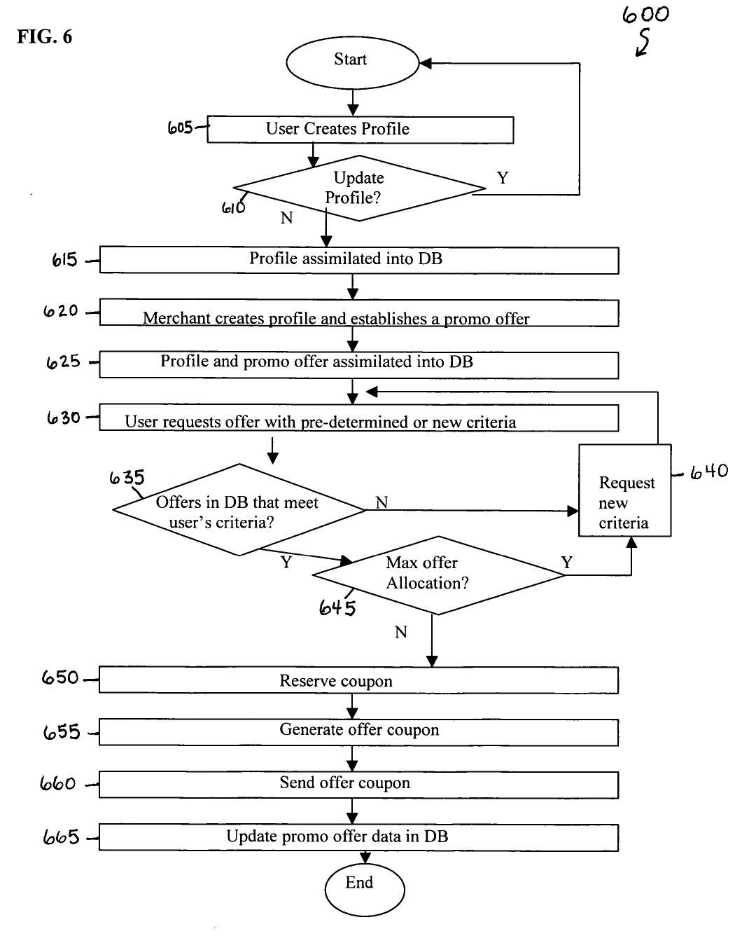

Referring now to FIG. 6, the reference numeral 600 generally designates a flow diagram illustrating the steps of an information and promotional offer management and distribution method in accordance with one embodiment of the present invention. The process begins at step 605, wherein a user creates a profile on the CMS. This step can be performed by, for example, user 108 creating a user profile on CMS 102 of FIG. 1 and/or user interaction module 314 of FIG. 3.

At next decisional step 610, a determination is made whether the user desires to update the user profile. This step can be performed by, for example, user interaction module 314 of FIG. 3. If at decisional step 610 it is determined that the user desires to update the user profile, the process continues along the YES branch and returns to step 605. If at decisional step 610 it is determined that the user does not desire to update the user profile, the process continues along the NO branch to step 615. At step 615, the user profile is assimilated into a user database. This step can be performed by, for example, user database 304 of FIG. 3.

At next step 620, a merchant creates a merchant profile and establishes a promotional offer. This step can be performed by, for example, merchant 118 establishing a merchant profile and establishing a promotional offer on CMS 102 of FIG. 1 and/or merchant interaction module 316 of FIG. 3. This step can also include the merchant establishing a referral profile. At next step 625, the merchant profile and promotional offer are assimilated into the merchant database and the offer database, respectively. This step can be performed by, for example, merchant database 306 and offer database 308 of FIG. 3.

At next step 630, the user requests a promotional offer with pre-determined or new criteria. This step can be performed by, for example, user 108 interacting with an IVR system of CMS 102 of FIG. 1. In one embodiment, the user profile created in step 605 includes user preference information that indicates what promotional offer types the user wishes to receive, whenever the user requests a promotional offer. In an alternate embodiment, the user can provide new criteria, such as, for example, a specific restaurant name, to request promotional offers related to that specified restaurant.

At next decisional step 635, a determination is made whether there are offers in the offer database that meet the user's criteria. This step can be performed by, for example, offer management module 318 of FIG. 3. If there are not offers in the offer database that meet the user's criteria, the process continues along the NO branch to step 640. At step 640, the user is prompted to provide new criteria. This step can be performed by, for example, user interaction module 314 of FIG. 3.

If there are offers in the offer database that meet the user's criteria, the process continues along the YES branch to decisional step 645. At decisional step 645 a determination is made whether the offers that meet the user's criteria have exceeded a merchant-specified maximum outstanding offer allotment. In an alternate embodiment, this step can be omitted. This step can be performed by, for example, offer tracking module 328 of FIG. 3. In an alternate embodiment, the user is presented with offer choices to select from, from a list of offers that meet a limited amount of the user's criteria, such as, for example, a specified restaurant or bar.

If the offers that meet the user's criteria have exceeded a merchant-specified maximum outstanding offer allotment, the process continues along the YES branch to step 640, wherein new criteria are requested. If the offers that meet the user's criteria have not exceeded a merchant-specified maximum outstanding offer allotment, the process continues along the NO branch to step 650.

At step 650 a promotional offer coupon is reserved for the user. This step can be performed by, for example, offer tracking module 328 of FIG. 3. At next step 655 a promotional offer coupon is generated. In one embodiment, the promotional offer coupon is a text message and takes the general format as illustrated in FIG. 5. This step can be performed by, for example, offer creation module 326 of FIG. 3. This step can include providing referral code and/or tracking information in the promotional offer coupon.

At next step 660, the promotional offer coupon is transmitted to the user and the process ends. This step can be performed by, for example, information dispersal module 324 and/or offer creation module 326 of FIG. 3. At next step 665 the offer information is updated in the offer database to reflect an issued promotional offer coupon. This step can be performed by, for example, offer tracking module 328 and/or offer management module 318 accessing offer database 308. This step can include updating referral information and therefore can include referral tracking and management module 342 updating referral database 340.

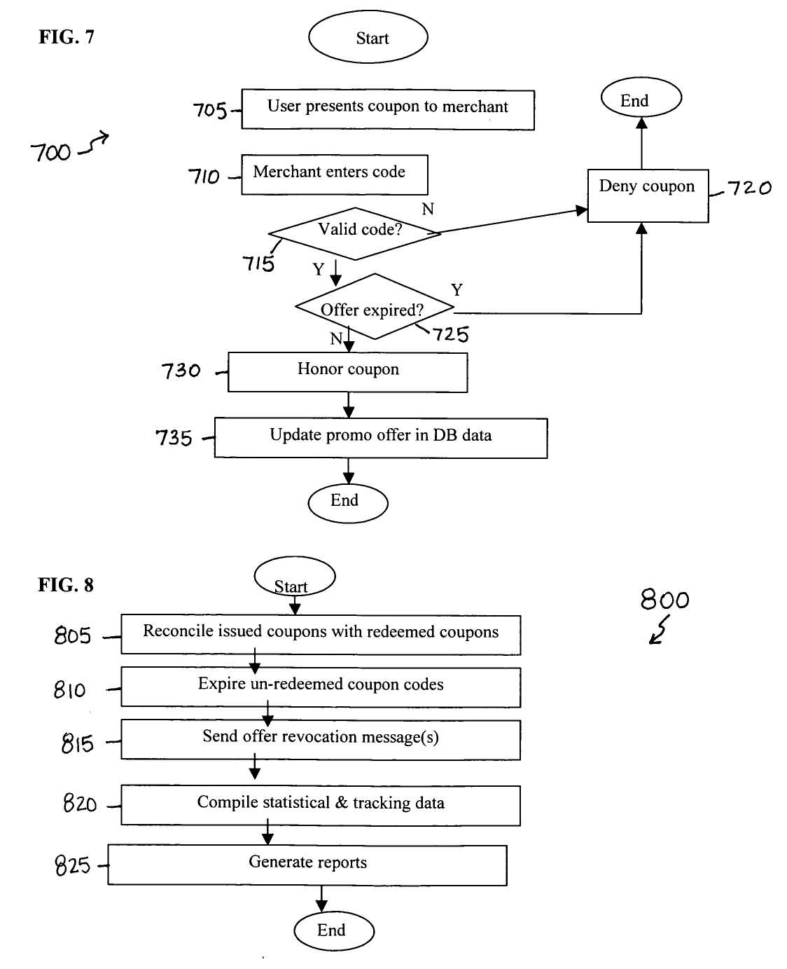

Referring now to FIG. 7, the reference numeral 700 generally designates a flow diagram illustrating the steps of an electronic promotional offer coupon redemption method in accordance with one embodiment of the present invention. The process begins at step 705, wherein a user presents a promotional offer coupon with a tracking code to a merchant. As described above, the tracking code can be a bar code and can include referral information. In an alternate embodiment, a separate referral code can also be included.

At next step 710, the merchant accesses the CMS and enters the tracking code. At next decisional step 715, a determination is made whether the tracking code is valid. If the tracking code is not valid, the process continues along the NO branch to step 720, wherein the coupon is denied. If the tracking code is valid, the process continues along the YES branch to decisional step 725 wherein a determination is made whether the offer has expired.

If the offer has expired, the process continues along the YES branch to step 720 wherein the coupon is denied. If the offer has not expired, the process continues along the NO branch to step 730. At step 730, the coupon is honored in accordance with the terms of the offer. At next step 735, the promotional offer information is updated based on the honored coupon. This step can include updating referral information as well as the offer, merchant, and user databases.

Referring now to FIG. 8, the reference numeral 800 generally designates a flow diagram illustrating an electronic promotional offer tracking and management method in accordance with one embodiment of the present invention. The process begins at step 805, wherein issued coupons are reconciled with redeemed coupons. At next step 810, un-redeemed coupons are expired. This step can include setting an invalid code in the offer database. At next step 815, offer revocation messages are sent to those users who have requested, but not redeemed promotional offer coupons. In a preferred embodiment, this step can be omitted.

At next step 820 statistical and tracking data is compiled. At next step 825, reports are generated based on compiled statistical and tracking data and the process ends.

It should be apparent from the foregoing that an invention having significant advantages has been provided. While the invention is shown in only a few of its forms, it is not just limited but is susceptible to various changes and modifications without departing from the spirit thereof.

We claim:

1. A method for information and promotional offer generation and distribution, comprising:
creating a user profile;
creating a merchant profile;
creating an offer profile;
receiving a request from a user for a promotional offer;
creating a promotional offer coupon with a unique tracking code based on the received request from the user, the user profile, and the offer profile;
sending the promotional offer coupon to the user based on the user profile; and
updating the offer profile to reflect the sent promotional offer coupon.

2. The method of claim 1 wherein the unique tracking code comprises a referral code.

3. A method for redeeming a promotional offer coupon, comprising:
presenting a promotional offer coupon to a merchant, the promotional offer coupon comprising a unique tracking code;
verifying the unique tracking code;
upon a determination that the unique tracking code is valid, honoring the promotional offer coupon; and
updating an offer database to reflect the honored promotional offer coupon.

4. The method of claim 3, wherein the unique tracking code comprises a referral code.

5. An electronic promotional offer coupon, comprising:
a promotional offer comprising terms;
a unique tracking code; and
wherein the electronic promotional offer coupon is embodied in an electronic messaging format.

6. The coupon of claim 5, wherein the electronic messaging format is short mail system (SMS)-text messaging.

7. The coupon of claim 5, wherein the electronic messaging format is electronic mail.

8. The coupon of claim 5, wherein the unique tracking code includes a referral code.
